(19) United States
(12) Patent Application Publication
(10) Pub. No.: US 2021/0002938 A1
(43) Pub. Date: Jan. 7, 2021

(54) MECHANICAL SPRING APPLIED IN FLOORS FOR OPENING AND CLOSING OF DOORS

(71) Applicants: Saulo Claro Ferreira, Campinas (BR); Aires dos Santos Diogenes, Jaguará do Sul (BR); Mauricio Pereira, Cuiabá (BR); Carlos Eduardo de Paulo, Cuiabá (BR); Edgar Stuelp Junior, Balneário Camboriu (BR); Reges de Lima Dias, Curitiba (BR); Marcos Antonio Nunes, Ponta Grossa (BR); Jeferson Alberti Bessani, Balneário Camboriu (BR); Lucas Santiago Ramos Guimarães, Florianopolis, SC (US); BOSTON INNOVATION GATEWAY LLC, Cambridge, MA (US)

(72) Inventors: Saulo Claro Ferreira, Campinas - SP (BR); Aires dos Santos Diogenes, Jaraguá do Sul - SC (BR)

(21) Appl. No.: 16/503,979

(22) Filed: Jul. 5, 2019

(51) Int. Cl. E05F 1/12

(52) U.S. Cl. CPC E05F 1/1207; E05Y 2900/132

(57) ABSTRACT

A device to be installed in any type of door, be it of glass, wood, aluminum or steel, in order to allow its automatic and controlled opening or closing, with minimum effort. The configuration 10 consists of a cap 20 and a wrapper 30, having in the inner part of the wrapper a plate-type spring 40, a fixed drum cam 50 and a movable drum cam 60. If the mechanical spring is installed in the center of the door, it can be rotated 360 degrees with displacement points at 90 degrees and 270 degrees and stop points at 180 degrees and 360 degrees.

### FIELD OF THE INVENTION

This utility model application is aimed at the construction industry and it refers to an innovative device that can be installed in any type of door, be it glass, wood, aluminum or steel, in order to allow its automatic and controlled opening or closing, with minimum effort.

### BACKGROUND OF THE INVENTION

Currently, springs installed on floors, whether hydraulic or pneumatic, are available on the market in several models and the primary function of these springs is to open and close doors automatically, the opening can stabilize at an angle of ninety degrees and closing or return to the threshold occurs smoothly.

Referring to the state of the art, reference can be made to U.S. Pat. No. 9,650,820B2 of the same inventor, which describes a compact structural arrangement having a pneumatic spring, installed in floors and shielded to prevent water from accumulating. Such pneumatic apparatus maintains the closed door 100 caused by the force exerted by an existing piston 80 and said door, upon being opened, rotates the pin 30 and the shoulder 60, which together with the double helicoid, pushes the descending rail (70) and the plunger (80).

Although hydraulic spring patterns have their own features and characteristics, the installation process is aesthetically complex, affecting the look of the floor in addition to generating a high cost, often greater than the value of the door itself. Another recurring problem is the possibility of infiltrating water into the mechanical assembly, promoting the oxidation of parts and, consequently, the need for repairs on the product.

In the case of pneumatic springs, such as that described in the aforementioned patent U.S. Pat. No. 9,650,820B2, the gradual loss of its controlled opening and closing function caused by leakage of trapped air has been observed, compromising the quality and full operation of the mechanical assembly. Associated with the loss of function, such leakage makes the spring susceptible to thermal variations, while reducing its useful life.

### SUMMARY OF THE INVENTION

Realizing the deficiencies of the admitted standards and interested in providing a more accessible configuration and capable of eliminating all the mentioned problems, the present invention discloses an innovative disposition applied in mechanical spring ready to attend any type of door and to be installed in practically all the floors, keeping the door automatically open or closed in points at every ninety degrees, with minimum effort, being able to return to the closed position smoothly without requiring efforts from the user.

### DESCRIPTION OF THE DRAWINGS

The following description seeks to highlight the invention at the level of its principle, without limiting itself to the designs or models of the components themselves, with reference to the following drawings listed below:

FIG. 1, shows the exploded isometric view demonstrating the preferred configuration of the mechanical spring and its components;

FIG. 2, shows the top view of the item entitled wrapper depicting its inner tangential shoulders;

FIG. 3 shows the lower view of the so-called drum cam component stressing its tangential grooves;

FIG. 4, shows the front view of the item called mobile drum cam and its sub-items;

FIG. 5 shows the frontal view in partial cuts representing the actuation of the internal components belonging to the mechanical spring.

FIG. 6 shows the frontal view in partial cuts representing the actuation of the internal components belonging to the mechanical spring.

### DETAILED DESCRIPTION OF THE INVENTION

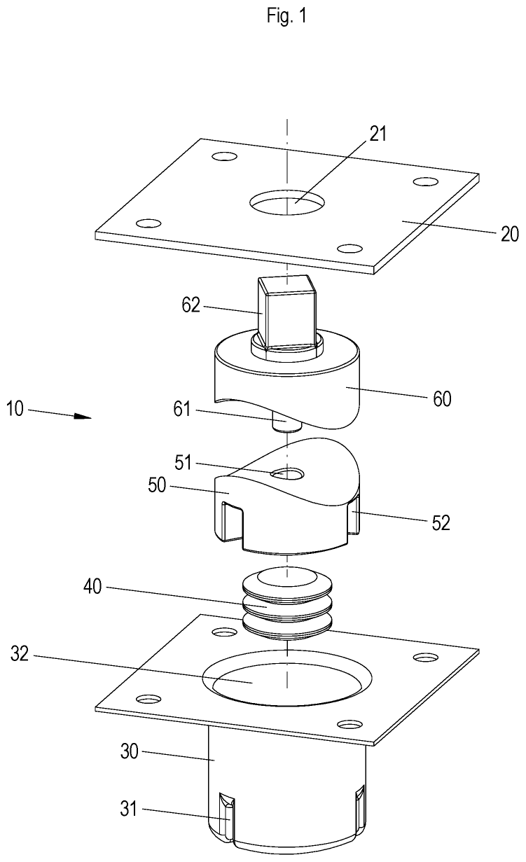

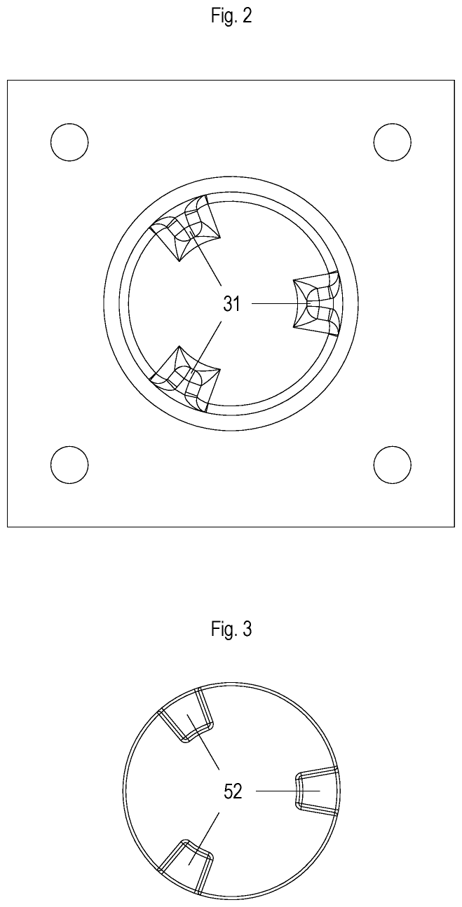

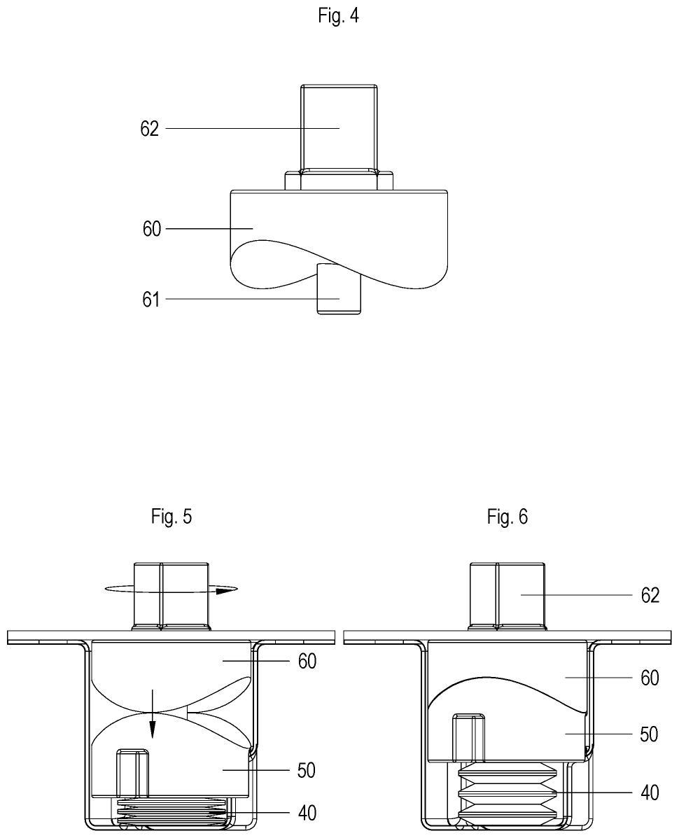

According to FIGS. 1 to 4, the mechanical spring loaded configuration 10 consists of a cap (20) with a centrally located through hole (21) and a wrapper (30) comprised of inner tangential shoulders (31) relief and opening in the upper section (32). In the inner part of the wrapper there is positioned a spring preferably of the plate (40) or helical type (not shown), with a fixed drum cam (50) provided with a central hole (51) and tangential grooves (52) that fit to the shoulders (31) of the wrapper (30) in order to hold it fixed. The above part, referred to as movable drum cam (60), remains crimped on the fixed drum cam (50), by inserting the insert (61) into the central hole (51), and has a top pin (62) preferably square cross-section and in charge of maintaining the door coupled.

The above top pin 62 can rotate at an angle of 180° and as it remains connected to the door, by moving it to open or close it, that pin simultaneously and radially drives the movable drum cam 60 (FIG. 5), its most prominent part coming into contact with the protrusion of the fixed drum cam (50), displacing it in the downward or axial direction without rotating it, since it is locked radially, compressing together the spring plate (40). When releasing the door, the spring plate 40 exerts its residual axial force by pushing up the fixed drum cam 50, which causes the movable drum cam 60 to return to their initial point (according to FIG. 6), moving the door in an automatic manner to close.

If the mechanical spring (10) is installed in the center of the door, it is possible to rotate 360°, with 90° and 270° displacement points and 180° and 360° stopping points.

### Advantages of the Invention

In comparison to the hydraulic spring, this improvement has very small dimensions, which reduces the aesthetic impact in the installed environment; has a reduced installation cost due to mechanical simplicity; the time required to install is reduced and requires only one hole in the floor, while the hydraulic spring requires at least one 300 mm hole in an operation of more than two and a half hours; its weight is considerably inferior when compared to the weight of the hydraulic spring, that can reach between 3 kg to 6 kg; it does not have problems with water leaking, it can be applied in numerous conditions without suffering damage.

Compared to the pneumatic spring, the present invention, in addition to maintaining the above-mentioned benefits, replaces compressed spring air of metallic material, such as steel, in the helical or flattened shape (commonly known as spring plate), or any other spring shape that brings this function; there is no need to introduce compressed air, making the manufacturing process much simpler, with fewer components and consequently lighter and more compact; because it has fewer components the impact on waste disposal is reduced; differently from the pneumatic spring that tends to lose pressure with temperature variation, it does not have problem with these variations, be it high or low, which significantly increasing its durability; it is easily configured for different door weights.

It should be emphasized that the invention disclosed should be understood in its representative and non-limiting detail and may undergo variations and modifications in its embodiment, provided that these modifications do not deviate from the essence of the invention claimed.

1- Mechanical spring applied in floors for opening and closing of doors, characterized by having a cap (20) with a centralized through hole (21) and a wrapper (30) composed of raised tangential shoulders (31) and opening in the upper section (40) below the so-called fixed drum cam (50), which is provided with a central hole (51) and tangential grooves (52) that adjust on the shoulders 31 of the wrapper 30, the movable drum cam 60 being engaged above the said fixed drum cam 50 by inserting the insert 61 into the central hole 51, it further has the drum cam (60) has a top pin (62) of the square cross-section.

2- Mechanical spring applied in floors for opening and closing of doors according to claim 1, characterized by the mechanical spring (10), when it is installed in the center of the door, rotates it 360° with displacement points at 90° and 270° and stop points at 180° and 360° degrees.
